(19) United States
(12) Patent Application Publication
(10) Pub. No.: US 2010/0168349 A1
(43) Pub. Date: Jul. 1, 2010

(54) PROCESS FOR PRODUCING ALPHA-OLEFIN POLYMERIZATION CATALYST

(75) Inventor: Yasuki FUJIWARA, Ichikawa-shi (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (JP)

(21) Appl. No.: 12/630,894

(22) Filed: Dec. 4, 2009

(30) Foreign Application Priority Data
Dec. 25, 2008 (JP) 2008-331128

(51) Int. Cl. C08F 4/76; C08F 10/00

(52) U.S. Cl. 526/116; 502/113

(57) ABSTRACT

A production process of an α-olefin polymerization catalyst, comprising the steps of (1) reducing a titanium compound represented by a defined formula with an organomagnesium compound in the presence of an Si—O bond-containing silicon compound, (2) contacting the resultant solid catalyst component precursor, a halogenating compound and an internal electron donor with one another, and (3) contacting the resultant solid catalyst component, an organoaluminum compound and a Si-containing external electron donor represented by a defined formula with one another; and a production process of an olefin polymer using the above catalyst.

### FIELD OF THE INVENTION

The present invention relates to a process for producing an α-olefin polymerization catalyst, and a process for producing an α-olefin polymer.

### BACKGROUND OF THE INVENTION

JP 7-216017A (corresponding to U.S. Pat. No. 5,608,018A) discloses a polymerization catalyst capable of producing highly stereoregular α-olefin polymers, the polymerization catalyst being produced according to a process comprising the steps of (i) reducing a titanium compound with an organomagnesium compound in the presence of a silicon compound and an ester compound, thereby obtaining a solid component containing magnesium atoms, titanium atoms and hydrocarbyloxy groups, (ii) treating the solid component with an ester compound, and (iii) contacting so-treated solid component with a halogenating compound (for example, titanium tetrachloride) and an electron donor (for example, ether compounds, or mixtures of ether compounds with ester compounds), thereby obtaining a solid catalyst component containing trivalent titanium compounds, and (iv) combining the solid catalyst component with an organoaluminum compound (cocatalyst component) and an electron donor (third catalyst component). Also, JP 10-212319A (corresponding to U.S. Pat. No. 6,187,883B) discloses a polymerization catalyst obtained according to a process comprising the steps of (i) contacting the above solid component with a halogenating compound (for example, titanium tetrachloride), an electron donor (for example, ether compounds, or mixtures of ether compounds with ester compounds) and organic acid halides, thereby obtaining a solid catalyst component containing trivalent titanium compounds, and (ii) combining the solid catalyst component with an organoaluminum compound (cocatalyst component) and an electron donor (third catalyst component).

As mentioned above, polymerization catalysts have been dramatically improved in their stereoregular polymerization ability. Those polymerization catalysts, however, may be so poor in their responsiveness to hydrogen gas, which is industrially used as a favorable molecular weight regulator for α-olefin polymers, that use of a lot of hydrogen gas is required for producing polypropylenes low in their molecular weight, and high in their rigidity. However, the use of a lot of hydrogen gas is one of limitations to a process for producing α-olefin polymers. In order to overcome the limitation, JP 2006-096936A discloses polymerization catalysts using specific silicon compounds as a third catalyst component.

### SUMMARY OF THE INVENTION

However, those polymerization catalysts disclosed in JP 2006-096936A are not satisfactory enough in their balance among molecular weight regulation by use of hydrogen gas, polymerization activity, and stereoregularity of α-olefin polymers obtained.

In view of the above circumstances, the present invention has an object to provide (i) a process for producing a highly active α-olefin polymerization catalyst excellent in its molecular weight regulation by use of hydrogen gas, and (ii) a process for producing a highly stereoregular α-olefin polymer by use of a highly active α-olefin polymerization catalyst produced according to the above production process.

The present invention is a process for producing an α-olefin polymerization catalyst, comprising the steps of:

(1) reducing a titanium compound represented by the following formula (I) with an organomagnesium compound in the presence of an Si-0 bond-containing silicon compound, thereby forming a solid catalyst component precursor;

(2) contacting the solid catalyst component precursor, a halogenating compound and an internal electron donor with one another, thereby forming a solid catalyst component containing titanium atoms, magnesium atoms and halogen atoms; and

(3) contacting the solid catalyst component, an organoaluminum compound and an external electron donor represented by the following formula (II) with one another;

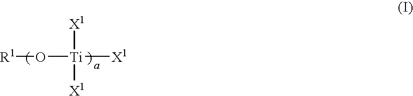

wherein R¹ is a hydrocarbyl group having 1 to 20 carbon atoms; X¹ is independently of one another a halogen atom or a hydrocarbyloxy group having 1 to 20 carbon atoms; and a is a number of 1 to 20, and preferably a number satisfying 1≦a≦5; and

R²Si(OC₂H₅)₃ (II)

wherein R² is a hydrocarbyl group having 3 to 20 carbon atoms, and a carbon atom contained in the hydrocarbyl group and directly linked to the silicon atom is a secondary carbon atom.

Also, the present invention is a process for producing an α-olefin polymer, comprising the step of homopolymerizing or copolymerizing an α-olefin in the presence of an α-olefin polymerization catalyst produced according to the above-mentioned production process.

The above “titanium compound represented by the formula (I)” and “Si—O bond-containing silicon compound” are referred to hereinafter as the “titanium compound” and the “silicon compound”, respectively.

### DETAILED DESCRIPTION OF THE INVENTION

The silicon compound used in the step (1) is preferably combined with an optionally-used ester compound, in order to obtain a polymerization catalyst further improved in its polymerization activity and stereoregular polymerization ability.

Examples of the silicon compound are those represented by the following formulas:

Si(OR⁵)ₜR⁶₄₋ₜ,

R⁷(R⁸₂SiO)ᵤSiR⁹₃, and

(R¹⁰₂SiO)ᵥ

wherein R⁵ is a hydrocarbyl group having 1 to 20 carbon atoms; R⁶ to R¹⁰ are independently of one another a hydrocarbyl group having 1 to 20 carbon atoms, or a hydrogen atom; t is a number satisfying 0<t≦4; u is a number of 1 to 1,000; and v is a number of 2 to 1,000.

Among them, preferred are alkoxysilanes represented by the above first formula, more preferred are those having t satisfying 1≦t≦4, most preferred are tetraalkoxysilanes having t of 4, and particularly preferred is tetraethoxysilane.

Examples of the silicon compound are tetramethoxysilane, dimethyldimethoxysilane, tetraethoxysilane, triethoxyethylsilane, diethoxydiethylsilane, ethoxytriethylsilane, tetraisopropoxysilane, diisopropoxydiisopropylsilane, tetrapropoxysilane, dipropoxydipropylsilane, tetrabutoxysilane, dibutoxydibutylsilane, dicyclopentoxydiethylsilane, diethoxydiphenylsilane, cyclohexyloxytrimethylsilane, phenoxytrimethylsilane, tetraphenoxysilane, triethoxyphenylsilane, hexamethyldisiloxane, hexaethyldisiloxane, hexapropyldisiloxane, octaethyltrisiloxane, dimethylpolysiloxane, diphenylpolysiloxane, methylhydropolysiloxane and phenylhydropolysiloxane.

Examples of R¹ in the above formula (I) are alkyl groups such as a methyl group, an ethyl group, a propyl group, an isopropyl group, a butyl group, an isobutyl group, an amyl group, an isoamyl group, a hexyl group, a heptyl group, an octyl group, a decyl group and a dodecyl group; aryl groups such as a phenyl group, a cresyl group, a xylyl group and a naphthyl group; cycloalkyl groups such as a cyclohexyl group and a cyclopentyl group; alkenyl groups such as a propenyl group; and aralkyl groups such a benzyl group.

R¹ is preferably alkyl groups having 2 to 18 carbon atoms, or aryl groups having 6 to 18 carbon atoms, and particularly preferably linear alkyl groups having 2 to 18 carbon atoms.

Examples of the halogen atom of X′ in the above formula (I) are a chlorine atom, a bromine atom and an iodine atom. Among them, a chlorine atom is particularly preferable.

Examples of the hydrocarbyloxy group having 1 to 20 carbon atoms of X¹ in the above formula (I) are hydrocarbyloxy groups derived from the above-exemplified hydrocarbyl groups of R¹. Among them, particularly preferred are linear alkoxy groups having 2 to 18 carbon atoms.

Examples of the titanium compound are tetramethoxytitanium, tetraethoxytitanium, tetra-n-propoxytitanium, tetraisopropoxytitanium, tetra-n-butoxytitanium, tetraisobutoxytitanium, n-butoxytitanium trichloride, di-n-butoxytitanium tri-n-butoxytitanium chloride, di-n-tetraisopropylpolytitanate which is a mixture of compounds having “a” of 2 to 10 in the above formula (I), tetra-n-butylpolytitanate which is a mixture of compounds having “a” of 2 to 10 in the above formula (I), tetra-n-hexylpolytitanate which is a mixture of compounds having “a” of 2 to 10 in the above formula (I), tetra-n-octylpolytitanate which is a mixture of compounds having “a” of 2 to 10 in the above formula (I), a condensate obtained by reacting tetraalkoxytitanium with a small amount of water, and a combination of two or more thereof.

Among them, preferred are titanium compounds having “a” of 1, 2 or 4 in the above formula (I), and particularly preferred is tetra-n-butoxytitanium, tetra-n-butyltitanium dimer, or tetra-n-butyltitanium tetramer.

The above organomagnesium compound is any compounds containing a magnesium-carbon bond therein. Preferable examples thereof are Grignard compounds represented by the following first formula, and dihydrocarbylmagnesium compounds represented by the following second formula, and Grignard compounds are preferable among them, and ether solutions of Grignard compounds are particularly preferable, in order to obtain a polymerization catalyst excellent in its polymerization activity and stereoregularity:

R¹¹MgX², and

R¹²R¹³Mg

wherein R¹¹ to R¹³ are a hydrocarbyl group having 1 to 20 carbon atoms; R¹² and R¹³ are the same as, or different from each other; and X² is a halogen atom.

Examples of R¹¹ to R¹³ are alkyl groups, aryl groups, aralkyl groups and alkenyl groups, those groups having 1 to 20 carbon atoms, such as a methyl group, an ethyl group, a propyl group, an isopropyl group, a butyl group, a sec-butyl group, a tert-butyl group, an isoamyl group, a hexyl group, an octyl group, a 2-ethylhexyl group, a phenyl group and a benzyl group.

Examples of X² in the above formula are a chlorine atom, a bromine atom and an iodine atom. Among them, a chlorine atom is particularly preferable.

The organomagnesium compound may be used as its complex with an organometal compound of Li, Be, B, Al or Zn, the complex being soluble in a hydrocarbon solvent.

Examples of the above ester compound are monocarboxylic acid esters and polycarboxylic acid esters. More specific examples thereof are saturated aliphatic carboxylic acid esters, unsaturated aliphatic carboxylic acid esters, alicyclic carboxylic acid esters, and aromatic carboxylic acid esters. Further specific examples thereof are methyl acetate, ethyl acetate, phenyl acetate, methyl propionate, ethyl propionate, ethyl butyrate, ethyl valerate, ethyl acrylate, methyl methacrylate, ethyl benzoate, butyl benzoate, methyl toluate, ethyl toluate, ethyl anisate, diethyl succinate, dibutyl succinate, diethyl malonate, dibutyl malonate, dimethyl maleate, dibutyl maleate, diethyl itaconate, dibutyl itaconate, monoethyl phthalate, dimethyl phthalate, methyl ethyl phthalate, diethyl phthalate, di-n-propyl phthalate, diisopropyl phthalate, di-n-butyl phthalate, diisobutyl phthalate, dipentyl phthalate, di-n-hexyl phthalate, di-n-heptyl phthalate, di-n-octyl phthalate, di(2-ethylhexyl)phthalate, diisodecyl phthalate, dicyclohexyl phthalate and diphenyl phthalate. Among them, preferred are unsaturated aliphatic carboxylic acid esters such as methacrylic acid esters and maleic acid esters, or aromatic carboxylic acid esters such as benzoic acid esters and phthalic acid esters, and particularly preferred are dialkyl phthalates.

The step (i) is carried out preferably by adding the organomagnesium compound to a mixture containing the silicon compound, the titanium compound and the optionally-used ester compound, whereby the titanium compound is reduced by the organomagnesium compound, and tetravalent titanium atoms contained in the titanium compound are reduced to trivalent titanium atoms. In the present invention, it is preferable that substantially all of those tetravalent titanium atoms are reduced to the trivalent titanium atoms.

Each of the silicon compound, the titanium compound and the optionally-used ester compound is preferably used in a solution or slurry state with a solvent.

Examples of the solvent are aliphatic hydrocarbons such as hexane, heptane, octane and decane; aromatic hydrocarbons such as toluene and xylene; alicyclic hydrocarbons such as cyclohexane, methylcyclohexane and decalin; ethers such as diethyl ether, di-n-butyl ether, diisoamyl ether and tetrahydrofuran; and combinations of two or more thereof.

The above reduction reaction is carried out at usually −50 to 70° C., preferably −30 to 50° C., and particularly preferably −25 to 35° C. An addition time of the organomagnesium compound is not particularly limited, and is usually 30 minutes to 10 hours. After addition of all the organomagnesium compound, the obtained reaction mixture may be further heated at 20 to 120° C. in order to promote the reduction reaction.

The above reduction reaction may use a carrier such as porous inorganic oxides and porous organic polymers, in order to support the resultant solid catalyst component precursor on the carrier. The carrier may be known in the art, and examples thereof are inorganic oxides such as SiO₂, Al₂O₃, MgO, TiO₂ and ZrO₂; and polymers such as polystyrene, a styrene-divinylbenzene copolymer, a styrene-ethylene glycol dimethacrylate copolymer, polymethyl acrylate, polyethyl acrylate, a methyl acrylate-divinylbenzene copolymer, polymethyl methacrylate, a methyl methacrylate-divinylbenzene copolymer, polyacrylonitrile, an acrylonitrile-divinylbenzene copolymer, polyvinyl chloride, polyethylene and polypropylene. Among them, preferred are organic polymers, and particularly preferred is a styrene-divinylbenzene copolymer or an acrylonitrile-divinylbenzene copolymer.

In order to support efficiently the solid catalyst component precursor on a carrier, the carrier has a pore volume of preferably 0.3 cm³/g or more, and more preferably 0.4 cm³/g or more, in a pore radius range of 20 to 200 nm. A ratio of the above pore volume is preferably 35% or more, and more preferably 40% or more, provided that the total pore volume in a pore radius range of 3.5 to 7,500 nm is 100%.

The silicon compound is used in an amount of usually 1 to 500 mol, preferably 1.5 to 300 mol, and particularly preferably 3 to 100 mol, in terms of an amount of silicon atoms contained in the silicon compound, per one mol of titanium atoms contained in the titanium compound used.

The organomagnesium compound is used in an amount such that the total amount of the above titanium atoms and silicon atoms is usually 0.1 to 10 mol, preferably 0.2 to 5.0 mol, and particularly preferably 0.5 to 2.0 mol, per one mol of magnesium atoms contained in the organomagnesium compound used.

Also, each of the titanium compound, the silicon compound and the organomagnesium compound may be determined in its used amount such that an amount of magnesium atoms contained in the obtained solid catalyst component precursor is 1 to 51 mol, preferably 2 to 31 mol, and particularly preferably 4 to 26, per one mol of titanium atoms contained in the solid catalyst component precursor.

The ester compound is used in an amount of usually 0.05 to 100 mol, preferably 0.1 to 60 mol, and particularly preferably 0.2 to 30 mol, per one mol of titanium atoms contained in the titanium compound used.

The resultant reduction reaction mixture is usually subjected to solid-liquid separation, thereby obtaining a solid catalyst component precursor, which is washed several times with inert solvents such as hexane and heptane.

The obtained solid catalyst component precursor contains trivalent titanium atoms, magnesium atoms and hydrocarbyloxy groups, and has generally an amorphous or very weak crystalline structure. Among them, particularly preferred is an amorphous structure, from a viewpoint of polymerization activity and stereoregularity of a polymerization catalyst obtained.

The halogenating compound is compounds capable of replacing hydrocarbyloxy groups contained in the solid catalyst component precursor with halogen atoms. Among them, preferred are halogen compounds of the group 4, 13 or 14 elements in the periodic table, or combinations of two or more of those compounds, and particularly preferred are halogen compounds of the group 4 or 14 elements.

The above halogen compounds of the group 4 elements are preferably those represented by the following formula:

M¹(OR¹⁴)_{b}X³_{4-b}

wherein M¹ is an atom of the group 4; R¹⁴ is a hydrocarbyl group having 1 to 20 carbon atoms, and when plural R¹⁴s exist, they are the same as, or different from one another; X³ is a halogen atom; and b is a number satisfying 0≦b<4, preferably a number satisfying 0≦b≦2, and particularly preferably b=0.

Examples of M¹ are a titanium atom, a zirconium atom and a hafnium atom. Among them, preferred is a titanium atom.

Examples of R¹⁴ are alkyl groups such as a methyl group, an ethyl group, a propyl group, an isopropyl group, a butyl group, an isobutyl group, a tert-butyl group, an amyl group, an isoamyl group, a tert-amyl group, a hexyl group, a heptyl group, an octyl group, a decyl group and a dodecyl group; aryl groups such as a pheny group, a cresyl group, a xylyl group, and a naphthyl group; alkenyl groups such as a propenyl group; and aralkyl groups such as a benzyl group. Among them, preferred are alkyl groups having 2 to 18 carbon atoms, or aryl groups having 6 to 18 carbon atoms, and particularly preferred are linear alkyl groups having 2 to 18 carbon atoms.

Examples of X³ are a chlorine atom, a bromine atom and an iodine atom. Among them, particularly preferred is a chlorine atom.

Examples of the halogen compounds represented by the above formula are titanium tetrahalides such as titanium tetrachloride, titanium tetrabromide, and titanium tetraiodide; alkoxytitanium trihalides such as methoxytitanium trichloride, ethoxytitanium trichloride, butoxytitanium trichloride, phenoxytitanium trichloride, and ethoxytitanium tribromide; dialkoxytitanium dihalides such as dimethoxytitanium dichloride, diethoxytitanium dichloride, dibutoxytitanium dichloride, diphenoxytitanium dichloride, and diethoxytitanium dibromide; and compounds obtained by replacing the titanium atom contained in the above compounds with a zirconium or hafnium atom. Among them, most preferred is titanium tetrachloride.

The above halogen compounds of the group 13 or 14 elements are preferably those represented by the following formula:

M²R¹⁵_{m-c}X⁴_{c}

wherein M² is an atom of the group 13 or 14; R¹⁵ is a hydrocarbyl group having 1 to 20 carbon atoms; X⁴ is a halogen atom; m is a valence of M², and when M² is a silicon atom, m is 4; c is a number satisfying 0<c≦m, and when M² is a silicon atom, c is preferably 3 or 4.

Examples of the atom of the group 13 are a boron atom, an aluminum atom, a gallium atom, an indium atom, and a thallium atom. Among them, preferred is a boron or aluminum atom, and more preferred is an aluminum atom. Examples of the atom of the group 14 are a silicon atom, a germanium atom, a tin atom, and a lead atom. Among them, preferred is a silicon, germanium or tin atom, and more preferred is a silicon atom.

Examples of X⁴ are a fluorine atom, a chlorine atom, a bromine atom and an iodine atom. Among them, preferred is a chlorine atom.

Examples of R¹⁵ are alkyl groups such as a methyl group, an ethyl group, a n-propyl group, an isopropyl group, a n-butyl group, an isobutyl group, an amyl group, an isoamyl group, a hexyl group, a heptyl group, an octyl group, a decyl group and a dodecyl group; aryl groups such as a pheny group, a tolyl group, a cresyl group, a xylyl group, and a naphthyl group; cycloalkyl groups such as a cyclohexyl group and a cyclopentyl group; alkenyl groups such as a propenyl group; and aralkyl groups such as a benzyl group. Among them, preferred are alkyl groups or aryl groups, and particularly preferred is a methyl group, an ethyl group, a n-propyl group, a phenyl group, or a p-tolyl group.

Examples of the halogen compounds of the group 13 elements are trichloroborane, methyldichloroborane, ethyldichloroborane, phenyldichloroborane, cyclohexyldichloroborane, dimethylchloroborane, methylethylchloroborane, trichloroaluminum, methyldichloroaluminum, ethyldichloroaluminum, phenyldichloroaluminum, cyclohexyldichloroaluminum, dimethylchloroaluminum, diethylchloroaluminum, methylethylchloroaluminum, ethylaluminum sesquichloride, gallium chloride, gallium dichloride, trichlorogallium, methyldichlorogallium, ethyldichlorogallium, phenyldichlorogallium, cyclohexyldichlorogallium, dimethylchlorogallium, methylethylchlorogallium, indium chloride, indium trichloride, methylindium dichloride, phenylindium dichloride, dimethylindium chloride, thallium chloride, thallium trichloride, methylthallium dichloride, phenylthallium dichloride and dimethylthallium chloride; and compounds obtained by replacing the chlorine atom contained in the above compounds with a fluorine atom, a bromine atom or an iodine atom.

Examples of the halogen compounds of the group 14 elements are tetrachloromethane, trichloromethane, dichloromethane, monochloromethane, 1,1,1-trichloroethane, 1,1-dichloroethane, 1,2-dichloroethane, 1,1,2,2-tetrachloroethane, tetrachlorosilane, trichlorosilane, methyltrichlorosilane, ethyltrichlorosilane, n-propyltrichlorosilane, n-butyltrichlorosilane, phenyltrichlorosilane, benzyltrichlorosilane, p-tolyltrichlorosilane, cyclohexyltrichlorosilane, dichlorosilane, methyldichlorosilane, ethyldichlorosilane, dimethyldichlorosilane, diphenyldichlorosilane, methylethyldichlorosilane, monochlorosilane, trimethylchlorosilane, triphenylchlorosilane, tetrachlorogermane, trichlorogermane, methyltrichlorogermane, ethyltrichlorogermane, phenyltrichlorogermane, dichlorogermane, dimethyldichlorogermane, diethyldichlorogermane, diphenyldichlorogermane, monochlorogermane, trimethylchlorogermane, triethylchlorogermane, tri-n-butylchlorogermane, tetrachlorotin, methyltrichlorotin, n-butyltrichlorotin, dimethyldichlorotin, di-n-butyldichlorotin, di-isobutyldichlorotin, diphenyldichlorotin, divinyldichlorotin, methyltrichlorotin, phenyltrichlorotin, dichlorolead, methylchlorolead and phenylchlorolead; and compounds obtained by replacing the chlorine atom contained in the above compounds with a fluorine atom, a bromine atom or an iodine atom. Among them, preferred is tetrachlorosilane, methyltrichlorosilane, ethyltrichlorosilane, n-propyltrichlorosilane, n-butyltrichlorosilane, phenyltrichlorosilane, tetrachlorotin, methyltrichlorotin or n-butyltrichlorotin.

The halogenating compound is particularly preferably titanium tetrachloride, methyldichloroaluminum, ethyldichloroaluminum, tetrachlorosilane, phenyltrichlorosilane, methyltrichlorosilane, ethyltrichlorosilane, n-propyltrichlorosilane or tetrachlorotin, from a viewpoint of an activity of a polymerization catalyst.

The above internal electron donor is preferably oxygen atom-containing compounds, nitrogen atom-containing compounds, phosphor atom-containing compounds, or sulfur atom-containing compounds. Examples of the oxygen atom-containing compounds are ethers, ketones, aldehydes, carboxylic acids, esters of organic or inorganic acids, ethers, acid amides of organic or inorganic acids, acid halides, and acid anhydrides. Examples of the nitrogen atom-containing compounds are ammonias, amines, nitriles, and isocyanates. Among them, preferred are phthalic acid derivatives, 1,3-diether compounds, or dialkyl ether compounds, and more preferred are phthalic acid derivatives.

Examples of the phthalic acid derivatives are compounds represented by the following formula:

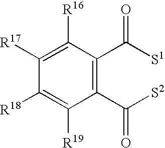

wherein R¹⁶ to R¹⁹ are independently of one another a hydrogen atom or a hydrocarbyl group; S¹ and S² are independently of each other a halogen atom or a substituent formed by combining any two or more selected from the group consisting of a hydrogen atom, a carbon atom, an oxygen atom and a halogen atom.

R¹⁶ to R¹⁹ are preferably a hydrogen atom, or hydrocarbyl groups having 1 to 10 carbon atoms, and any two or more selected from R¹⁶ to R¹⁹ may be linked with one another to form a ring. S¹ and S² are independently of each other preferably a chlorine atom, a hydroxyl group, or an alkoxy group having 1 to 20 carbon atoms.

Examples of the phthalic acid derivatives are phthalic acid, monoethyl phthalate, dimethyl phthalate, methyl ethyl phthalate, diethyl phthalate, di-n-propyl phthalate, diisopropyl phthalate, di-n-butyl phthalate, diisobutyl phthalate, dipentyl phthalate, di-n-hexyl phthalate, di-n-heptyl phthalate, diisoheptyl phthalate, di-n-octyl phthalate, di(2-ethylhexyl)phthalate, di-n-decyl phthalate, diisodecyl phthalate, dicyclohexyl phthalate, diphenyl phthalate, and phthaloyl dichloride.

Among the phthalic acid derivatives represented by the above formula, preferred are phthalic esters having S¹ and S² of c₁₋₆ alkoxy groups, and more preferred is diethyl phthalate, di-n-propyl phthalate, diisopropyl phthalate, di-n-butyl phthalate, or diisobutyl phthalate.

Examples of the above 1,3-diether compounds are compounds represented by the following formula:

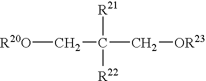

wherein R²⁰ to R²³ are independently of one another a linear, branched or alicyclic alkyl, aryl or aralkyl group having 1 to 20 carbon atoms, and R²¹ and R²² may be independently of each other a hydrogen atom.

Examples of the 1,3-diether compounds are 2,2-diisobutyl-1,3-dimethoxypropane, 2-isopropyl-2-isopentyl-1,3-dimethoxypropane, 2,2-bis(cyclohexylmethyl)-1,3-dimethoxypropane, 2-isopropyl-2-dimethyloctyl-1,3-dimethoxypropane, 2,2-diisopropyl-1,3-dimethoxypropane, 2-isopropyl-2-cyclohexylmethyl-1,3-dimethoxypropane, 2,2-dicyclohexyl-1,3-dimethoxypropane, 2-isopropyl-2-isobutyl-1,3-dimethoxypropane, 2,2-dipropyl-1,3-dimethoxypropane, 2-isopropyl-2-cyclohexyl-1,3-dimethoxypropane, 2-isopropyl-2-cyclopentyl-1,3-dimethoxypropane, 2,2-dicyclopentyl-1,3-dimethoxypropane, and 2-n-heptyl-2-isopentyl-1,3-dimethoxypropane. Among them, preferred is 2-isopropyl-2-isobutyl-1,3-dimethoxypropane, 2-isopropyl-2-isopentyl-1,3-dimethoxypropane, 2,2-diisobutyl-1,3-dimethoxypropane, 2,2-diisopropyl-1,3-dimethoxypropane, or 2,2-dicyclopentyl-1,3-dimethoxypropane.

Examples of the above dialkyl ether compounds are those represented by the following formula:

R24-O—R²⁵

wherein R²⁴ and R²⁵ are independently of each other a linear, branched or alicyclic alkyl group having 1 to 20 carbon atoms.

Examples of the dialkyl ether compounds are dimethyl ether, diethyl ether, di-n-propyl ether, diisopropyl ether, di-n-butyl ether, diisobutyl ether, di-n-amyl ether, diisoamyl ether, methyl ethyl ether, methyl-n-butyl ether, and methyl cyclohexyl ether. Among them, preferred is di-n-butyl ether.

The step (2) may optionally use organic acid halides. Examples thereof are monocarboxylic acid halides and polycarboxylic acid halides. More specific examples thereof are aliphatic carboxylic acid halides, alicyclic carboxylic acid halides, and aromatic carboxylic acid halides. Further specific examples thereof are acetyl chloride, propionyl chloride, butyryl chloride, valeryl chloride, acryloyl chloride, methacryloyl chloride, benzoyl chloride, toluoyl chloride, anisoyl chloride, succinoyl chloride, malonoyl chloride, maleinoyl chloride, itaconoyl chloride, and phthaloyl chloride. Among them, preferred are aromatic carboxylic acid chlorides such as benzoyl chloride, toluoyl chloride and phthaloyl chloride, further preferred are aromatic dicarboxylic acid dichloride, and particularly preferred is phthaloyl chloride.

The step (2) is carried out by contacting the solid catalyst component precursor, the halogenating compound, the internal electron donor, and the optional organic acid halide with one another, usually in an atmosphere of an inert gas such as argon. Examples of a method for contacting them are as follows:

(1) a method comprising the step of adding the halogenating compound and the internal electron donor, in any order, to the solid catalyst component precursor;

(2) a method comprising the step of adding a mixture of the halogenating compound with the internal electron donor and the organic acid halide to the solid catalyst component precursor;

(3) a method comprising the step of adding a mixture of the halogenating compound with the internal electron donor, and the organic acid halide, in any order, to the solid catalyst component precursor;

(4) a method comprising the step of adding the internal electron donor and the halogenating compound, in this order, to the solid catalyst component precursor;

(5) a method comprising the step of adding the internal electron donor, the halogenating compound, and further internal electron donor, in any order, to the solid catalyst component precursor;

(6) a method comprising the step of adding the internal electron donor, and a mixture of the halogenating compound with further internal electron donor, in this order, to the solid catalyst component precursor;

(7) a method comprising the step of adding the solid catalyst component precursor and the internal electron donor, in any order, to the halogenating compound; and

(8) a method comprising the step of adding the solid catalyst component precursor, the internal electron donor, and the organic acid halide, in any order, to the halogenating compound.

More examples are modifications of the above methods (1) to (8), which contain one or more steps of contacting the respective final contact products obtained in the above methods (1) to (8) with further halogenating compound with, or which contain one or more steps of contacting the respective final contact products obtained in the above methods (1) to (8) with a mixture of further halogenating compound with further internal electron donor.

Among them, preferred is the method (3); a modification of the method (3), which contains one or more steps of contacting the final contact product obtained in the method (3) with a mixture of further halogenating compound with further internal electron donor; the method (6); or a modification of the method (6), which contains one or more steps of contacting the final contact product obtained in the method (6) with a mixture of further halogenating compound with further internal electron donor. More preferred is the method (3) carried out in the above-specified contact order; a modification of the contact order-specified method (3), which contains one or more steps of contacting the final contact product obtained in the contact order-specified method (3) with a mixture of further halogenating compound with further internal electron donor; the method (6); or the above modification of the method (6). Particularly preferred is the following method (a) or (b):

(a) a modification of the method (3), which comprises the steps of (a-1) adding a mixture of the halogenating compound with a dialkyl ether compound (internal electron donor), and the organic acid halide, in this order, to the solid catalyst component precursor, then (a-2) adding a mixture of the halogenating compound with a phthalic acid derivative (internal electron donor) and a dialkyl ether compound (internal electron donor), and further (a-3) adding one more times a mixture of the halogenating compound with a dialkyl ether compound (internal electron donor); or

(b) a modification of the method (6), which comprises the steps of (b-1) adding a phthalic acid derivative (internal electron donor) to the solid catalyst component precursor, then (b-2) adding a mixture of the halogenating compound with a phthalic acid derivative (internal electron donor) and a dialkyl ether compound (internal electron donor), and further (b-3) adding one more times a mixture of the halogenating compound with a dialkyl ether compound (internal electron donor).

The step (2) is not particularly limited in its contact method. Examples of the method are those known in the art such as a slurry method and a mechanically-crushing method (for example, ball mill-crushing method). The mechanically-crushing method is carried out preferably in the presence of a solvent, in order to control an amount of fine powders contained in the solid catalyst component obtained, and also in order to control broadening of a particle size distribution of the solid catalyst component obtained.

The solid catalyst component obtained in the step (2) is preferably washed with a solvent to remove impurities contained therein. The solvent is preferably inert to the solid catalyst component. Examples of the solvent are aliphatic hydrocarbons such as pentane, hexane, heptane and octane; aromatic hydrocarbons such as benzene, toluene and xylene; alicyclic hydrocarbons such as cyclohexane and cyclopentane; and halogenated hydrocarbons such as 1,2-dichloroethane and monochlorobenzene. Among them, particularly preferred are aromatic hydrocarbons or halogenated hydrocarbons.

The step (2) usually uses a solvent in an amount of usually 0.1 to 1,000 mL, and preferably 1 to 100 mL, per one g of the solid catalyst component precursor, per one contact. An amount of a solvent used for washing a solid catalyst component obtained in the step (2) is similar to that mentioned above, per one washing. Washing is carried out usually 1 to 5 times after every contact.

Contacts and washings in the step (2) are carried out at usually −50 to 150° C., preferably 0 to 140° C., and further preferably 60 to 135° C. A contact time in the step (2) is not particularly limited, and is preferably 0.5 to 8 hours, and further preferably 1 to 6 hours. A washing time in the step (2) is not particularly limited, and is preferably 1 to 120 minutes, and further preferably 2 to 60 minutes.

The internal electron donor is used in an amount of usually 0.01 to 100 mmol, preferably 0.05 to 50 mmol, and further preferably 0.1 to 20 mmol, per one gram of the solid catalyst component precursor. When the amount is more than 100 mmol, particles of the solid catalyst component precursor may be broken.

Particularly, phthalic acid derivatives (internal electron donor) are used in an amount such that the solid catalyst component contains the phthalic acid derivatives in an amount of preferably 1 to 25% by weight, and more preferably 2 to 20% by weight, the total of the solid catalyst component being 100% by weight. Also, the phthalic acid derivatives are used in an amount of usually 0.1 to 100 mmol, preferably 0.3 to 50 mmol, and further preferably 0.5 to 20 mmol, per one g of the solid catalyst component precursor. Further, the phthalic acid derivatives are used in an amount of usually 0.01 to 1.0 mol, and preferably 0.03 to 0.5 mol, per one mol of magnesium atoms contained in the solid catalyst component precursor.

1,3-Diether compounds (internal electron donor) are used in an amount such that the solid catalyst component contains the 1,3-diether compounds in an amount of preferably 0.5 to 20% by weight, and more preferably 0.8 15% by weight, the total of the solid catalyst component being 100% by weight. Also, the 1,3-diether compounds are used in an amount of usually 0.01 to 100 mmol, preferably 0.015 to 50 mmol, and further preferably 0.02 to 10 mmol, per one g of the solid catalyst component precursor. Further, the 1,3-diether compounds are used in an amount of usually 0.001 to 1.0 mol, and preferably 0.002 to 0.5 mol, per one mol of magnesium atoms contained in the solid catalyst component precursor.

When using a combination of the phthalic acid derivatives with the 1,3-diether compounds as the internal electron donor, the combination is used in an amount such that the solid catalyst component contains the 1,3-diether compounds in an amount of preferably 0.1 to 3 mol, more preferably 0.13 to 2 mol, and further preferably 0.15 to 1.5 mol, per one mol of the phthalic acid derivatives contained in the solid catalyst component. Also, the total of the above combination is contained in the solid catalyst component in an amount of preferably 5 to 30% by weight, and more preferably 6 to 25% by weight, the total of the solid catalyst component being 100% by weight, from a viewpoint of its stereoregular polymerization ability.

The halogenating compound is used in an amount of usually 0.5 to 1,000 mmol, preferably 1 to 200 mmol, and further preferably 2 to 100 mmol, per one gram of the solid catalyst component precursor. The halogenating compound is used preferably in combination with dialkyl ether compounds, and the dialkyl ether compounds are used in an amount of usually 1 to 100 mol, preferably 1.5 to 75 mol, and further preferably 2 to 50 mol, per one mol of the halogenating compound.

The organic acid halide is used in an amount of usually 0.1 to 100 mmol, preferably 0.3 to 50 mmol, and further preferably 0.5 to 20 mmol, per one g of the solid catalyst component precursor. Also, the organic acid halide is used in an amount of usually 0.01 to 1.0 mol, and preferably 0.03 to 0.5 mol, per one mol of magnesium atoms contained in the solid catalyst component precursor. When the amount of the organic acid halide is more than 100 mmol, per one g of the solid catalyst component precursor, or is more than 1.0 mol, per one mol of magnesium atoms contained in the solid catalyst component precursor, particles of the solid catalyst component precursor may be broken.

The above used amounts of the respective compounds are those per one contact. Therefore, when two or more contacts are carried out, the above respective amounts are applied to each of those contacts.

The solid catalyst component obtained in the step (2) may be used for polymerization in a form of its slurry by combining with an inert solvent, or may be used for polymerization in a form of its fluid dry powder. Examples of a drying method for obtaining the fluid dry powder are a reduced-pressure drying method, and a method comprising the step of removing volatile matters contained in the solid catalyst component under a flow of an inert gas such as nitrogen and argon. The drying is carried out at preferably 0 to 200° C., and more preferably 50 to 100° C., and for preferably 0.01 to 20 hours, and more preferably 0.5 to 10 hours.

The solid catalyst component has a weight-average particle diameter of preferably 13 to 100 μm, more preferably 15 to 80 μm, and further preferably 17 to 60 μm, from an industrial point of view. The solid catalyst component contains particles having a diameter of 10 μm or smaller in an amount of preferably 6% by weight or less, and more preferably 4% by weight or less, the total of the solid catalyst component being 100% by weight, because an amount of more than 6% by weight of particles having a diameter of 10 μm or smaller may produce unfavorable agglomerates in gas-phase polymerization, or may occlude pipes in a polymerization system, which may result in unstable polymer production.

Use of the above solid catalyst component can produce effectively α-olefin polymers having high stiffness.

The organoaluminum compound in the step (3) is a compound having one or more aluminum-carbon bonds in its molecule. Examples thereof are compounds represented by the following formulas, respectively:

R²⁴_{w}AlY_{3-w}, and

R²⁵R²⁶Al—O—AlR²⁷R²⁸,

wherein R²⁴ to R²⁸ are independently of one another a hydrocarbyl group having 1 to 20 carbon atoms; Y is a halogen atom, a hydrogen atom or an alkoxy group; and w is a number satisfying 2≦w≦3.

Examples of compounds represented by the above formulas are trialkylaluminums such as triethylaluminum, triisobutylaluminum and trihexylaluminum; dialkylaluminum hydrides such as diethylaluminum hydride and diisobutylaluminum hydride; dialkylaluminum halides such as diethylaluminum chloride; mixtures of trialkylaluminums and dialkylaluminum halides such as a mixture of triethylaluminum and diethylaluminum chloride; and alkylalumoxanes such as tetraethyldialumoxane and tetrabutyldialumoxane.

Among them, preferred are trialkylaluminums, mixtures of trialkylaluminums with dialkylaluminum halides, or alkylalumoxanes; and particularly preferred is triethylaluminum, triisobutylaluminum, a mixture of triethylaluminum with diethylaluminum chloride, or tetraethyldialumoxane, from a viewpoint of polymerization activity of catalysts obtained, and stereoregularity of polymers obtained.

Examples of the external electron donor represented by the formula (II) in the step (3) are isopropyltriethoxysilane, sec-butyltriethoxysilane, sec-hexyltriethoxysilane, sec-amyltriethoxysilane, cyclohexyltriethoxysilane, 2-methylcyclohexyltriethoxysilane, 2-ethylcyclohexyltriethoxysilane, 2,6-dimethylcyclohexyltriethoxysilane, 2,6-diethylcyclohexyltriethoxysilane, cyclopentyltriethoxysilane, 2-methylcyclopentyltriethoxysilane, 2-ethylcyclopentyltriethoxysilane, 2,5-dimethylcyclopentyltriethoxysilane, and 2,5-diethylcyclopentyltriethoxysilane. Among them, preferred is sec-butyltriethoxysilane, cyclohexyltriethoxysilane, or cyclopentyltriethoxysilane.

In the step (3), compounds having a bond —C—O—C—O—C— may be brought into contact. Examples of the compounds are those represented by the following formula (III):

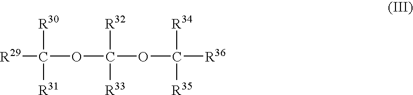

wherein R²⁹ to R³⁶ are independently of one another a hydrogen atom, a hydrocarbyl group having 1 to 20 carbon atoms, or a hydrocarbyloxy group having 1 to 20 carbon atoms, and any two or more of R²⁹ to R³⁶ may be linked with one another, to form a ring. Also, there are exemplified compounds derived from the formula (III), wherein any two of three carbon atoms contained in the bond —C—O—C—O—C— are linked with each other to form a ring, and each of those two carbon atoms does not carry either one of R²⁹ to R³⁶. Examples of those compounds are compounds, wherein the carbon atom carrying R²⁹ is linked with the carbon atom carrying R³⁶ to form a five-membered ring, and those two carbon atoms do not carry R²⁹ and R³⁶, respectively.

Examples of R²⁹ to R³⁶ are a methyl group, an ethyl group, a n-propyl group, an isopropyl group, a n-butyl group, an isobutyl group, a tert-butyl group, a n-pentyl group, an isopentyl group, a neopentyl group, a cyclopentyl group, a n-hexyl group, an isohexyl group, a cyclohexyl group, a n-heptyl group, a n-octyl group, a 2-ethylhexyl group, a n-decyl group, an isodecyl group, a phenyl group, a methoxy group, an ethoxy group, a n-propoxy group, an isopropoxy group, a n-butoxy group, an isobutoxy group, a tert-butoxy group, a n-pentoxy group, an isopentoxy group, a neopentoxy group, a n-hexoxy group, and an isohexoxy group.

Examples of the compounds represented by the formula (III) are dimethyl acetal, diethyl acetal, propylenealdehyde dimethyl acetal, n-octylaldehyde dimethyl acetal, benzaldehyde dimethyl acetal, 2,2-dimethoxypropane, 3,3-dimethoxyhexane, and 2,6-dimethyl-4,4-dimethoxyheptane.

Examples of the compounds represented by the formula (III), wherein any two or more of R²⁹ to R³⁶ are linked with one another to form a ring, or examples of the compounds derived from the formula (III), wherein any two of three carbon atoms contained in the bond —C—O—C—O—C— are linked with each other to form a ring, and each of those two carbon atoms does not carry either one of R²⁹ to R³⁶, are 1,1-dimethoxycyclopentane, 1,1-dimethoxycyclohexane, 1,1-diethoxycyclopentane, 1,1-diethoxycyclohexane, 2-methoxytrimethylene oxide, 2-ethoxytrimethylene oxide, 2,4-dimethoxytrimethylene oxide, 2,4-diethoxytrimethylene oxide, 2-methoxytetrahydrofuran, 2-ethoxytetrahydrofuran, 2,5-dimethoxytetrahydrofuran, 2,5-diethoxytetrahydrofuran, 2-methoxytetrahydropyrane, 2-ethoxytetrahydropyrane, 2,6-dimethoxytetrahydropyrane, 2,6-diethoxytetrahydropyrane, 1,3-dioxolan, 2-methyl-1,3-dioxolan, 4-methyl-1,3-dioxolan, 2,2-dimethyl-1,3-dioxolan, 2,4-dimethyl-1,3-dioxolan, 2-methoxy-1,3-dioxolan, 4-methoxy-1,3-dioxolan, 2,2-dimethoxy-1,3-dioxolan, 1,3-dioxane, 2-methyl-1,3-dioxane, 4-methyl-1,3-dioxane, 2,2-dimethyl-1,3-dioxane, 2,4-dimethyl-1,3-dioxane, 2-methoxy-1,3-dioxane, 4-methoxy-1,3-dioxane, 2,2-dimethoxy-1,3-dioxane, 2,4-dimethoxy-1,3-dioxane, 1,3-dioxepane, 2-methyl-1,3-dioxepane, 4-methyl-1,3-dioxepane, 5-methyl-1,3-dioxepane, 2,4-dimethyl-1,3-dioxepane, 2,5-dimethyl-1,3-dioxepane, 2-methoxy-1,3-dioxepane, 4-methoxy-1,3-dioxepane, 5-methoxy-1,3-dioxepane, and s-trioxane.

Among them, preferred are compounds represented by the formula (III), wherein R²⁹ is linked with R³⁶ to form a ring, or are compounds derived from the formula (III), wherein the carbon atom carrying R²⁹ is linked with the carbon atom carrying R³⁶ to form a five-membered ring. Particularly preferred is 1,3-dioxaran, 1,3-dioxane, 1,3-dioxepane, or s-trioxane.

Examples of a method for the contacting in the step (3) are (i) a method comprising the steps of contacting all of the components, thereby forming a contact product (i.e., polymerization catalyst), and then supplying the contact product to a polymerization reactor, (ii) a method comprising the step of supplying those components separately to a polymerization reactor, thereby contacting those components with one another in the polymerization reactor to form a polymerization catalyst, (iii) a method comprising the steps of contacting some parts of those components with one another, thereby forming a contact product, then contacting the contact product with remaining parts of those components, thereby forming a polymerization catalyst, and then supplying the polymerization catalyst to a polymerization reactor, and (vi) a method comprising the steps of contacting some parts of those components with one another, thereby forming a contact product, and then supplying the contact product and the remaining parts of those components separately to a polymerization reactor, thereby contacting them with each other in the polymerization reactor to form a polymerization catalyst.

The solid catalyst component, the organoaluminum compound, the external electron donor, and optionally-used components may be combined with a solvent, respectively.

The above supplying to a polymerization reactor is carried out usually in a water-free state and in an atmosphere of an inert gas such as nitrogen and argon.

In order to produce α-olefin polymers having a good powder property, the solid catalyst component used in the step (3) is preferably a pre-polymerized solid catalyst component, as produced below. The pre-polymerized solid catalyst component can be produced by polymerizing a small amount of an olefin in the presence of the above-mentioned solid catalyst component and organoaluminum compound, wherein (i) the olefin is the same as, or different from an α-olefin used in the production process of α-olefin polymers of the present invention in its type, and (ii) a chain-transfer agent such as hydrogen, or the above-mentioned external electron donor, or the above-mentioned compounds having a bond —C—O—C—O—C— may be used. The above polymerization for producing the pre-polymerized solid catalyst component is generally referred to as a “pre-polymerization” in contrast to the “main polymerization” in the production process of α-olefin polymers of the present invention. The pre-polymerized solid catalyst component is, in other words, a modified solid catalyst component, whose surface is covered by the resultant polymer. Such pre-polymerization is disclosed in U.S. Pat. Nos. 6,187,883 and 6,903,041.

Therefore, a process for producing an α-olefin polymerization catalyst using a pre-polymerized solid catalyst component comprises the following steps (2-1) and (2-2) between the steps (2) and (3):

(2-1) contacting the solid catalyst component containing titanium atoms, magnesium atoms and halogen atoms formed in the step (2) with an organoaluminum compound, thereby forming a contact product; and

(2-2) polymerizing an olefin in the presence of the contact product, thereby forming a pre-polymerized solid catalyst component.

So formed pre-polymerized solid catalyst component is used in the step (3) as the solid catalyst component.

The above pre-polymerization is preferably a slurry polymerization in an inert hydrocarbon solvent such as propane, butane, isobutane, pentane, isopentane, hexane, heptane, octane, cyclohexane, benzene and toluene.

The organoaluminum compound in the pre-polymerization is used in an amount of generally 0.5 to 700 mol, preferably 0.8 to 500 mol, and particularly preferably 1 to 200 mol, per one mol of titanium atoms contained in the solid catalyst component used in the pre-polymerization.

The olefin in the pre-polymerization is pre-polymerized in an amount of generally 0.01 to 1,000 g, preferably 0.05 to 500 g, and particularly preferably 0.1 to 200 g, per one gram of the solid catalyst component used in the pre-polymerization.

The pre-polymerization is preferably a slurry polymerization, and the slurry concentration of the solid catalyst component is preferably 1 to 500 g-solid catalyst component/liter-solvent, and particularly preferably 3 to 300 g-solid catalyst component/liter-solvent.

The pre-polymerization is carried out at preferably −20 to 100° C., and particularly preferably 0 to 80° C., and under a partial pressure of an olefin in a gas phase of preferably 0.01 to 2 MPa, and particularly preferably 0.1 to 1 MPa, provided that an olefin in a liquid state under a pre-polymerization temperature and a pre-polymerization pressure is not limited thereto. A pre-polymerization time is not particularly limited, and is preferably 2 minutes to 15 hours.

The solid catalyst component, organoaluminum compound and olefin are supplied to a pre-polymerization reactor according to the below-exemplified method (i) or (ii):

(i) a method comprising the steps of feeding the solid catalyst component and the organoaluminum compound, and then feeding the olefin; or

(ii) a method comprising the steps of feeding the solid catalyst component and the olefin, and then feeding the organoaluminum compound.

The olefin in the pre-polymerization is supplied to a pre-polymerization reactor according to the below-exemplified method (i) or (ii):

(i) a method of sequentially feeding the olefin to the pre-polymerization reactor, so as to keep an inner pressure of the pre-polymerization reactor at a predetermined level; or

(ii) a method of feeding a predetermined total amount of the olefin at the same time to the pre-polymerization reactor.

The pre-polymerization preferably uses an external electron donor. Preferable examples of the external electron donor are those represented by the following formula (IV) or (C2), and further preferable examples are those represented by the above formula (II) or the following formula (V):

R³ₙSi(OR⁴)₄₋ₙ (IV)

wherein R³ is a hydrocarbyl group having 1 to 20 carbon atoms, a hydrogen atom, or a heteroatom-containing group, and when plural R³s exist, they are the same as, or different from one another; R⁴ is a hydrocarbyl group having 1 to 20 carbon atoms, and when plural R⁴s exist, they are the same as, or different from one another; and n is a number of 1 to 3;

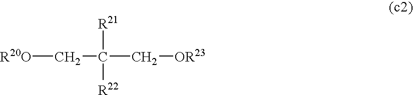

wherein R²⁰ to R²³ are already defined above.

R³⁷R³⁸Si(OCH₃)₂ (V)

wherein R³⁷ and R³⁸ are a hydrocarbyl group having 1 to 20 carbon atoms, a hydrogen atom, or a heteroatom-containing group, and R³⁷ and R³⁸ are the same as, or different from each other.

Examples of the external electron donor represented by the formula (V) are diisopropyldimethoxysilane, diisobutyldimethoxysilane, di-tert-butyldimethoxysilane, tert-butylmethyldimethoxysilane, tert-butylethyldimethoxysilane, tert-butyl-n-propyldimethoxysilane, tert-butyl-n-butyldimethoxysilane, tert-amylmethyldimethoxysilane, tert-amylethyldimethoxysilane, tert-amyl-n-propyldimethoxysilane, tert-amyl-n-butyldimethoxysilane, isobutylisopropyldimethoxysilane, tert-butylisopropyldimethoxysilane, dicyclobutyldimethoxysilane, cyclobutylisopropyldimethoxysilane, cyclobutylisobutyldimethoxysilane, cyclobutyl-tert-butyldimethoxysilane, dicyclopentyldimethoxysilane, cyclopentylisopropyldimethoxysilane, cyclopentylisobutyldimethoxysilane, cyclopentyl-tert-butyldimethoxysilane, dicyclohexyldimethoxysilane, cyclohexylmethyldimethoxysilane, cyclohexylethyldimethoxysilane, cyclohexylisopropyldimethoxysilane, cyclohexylisobutyldimethoxysilane, cyclohexyl-tert-butyldimethoxysilane, cyclohexylcyclopentyldimethoxysilane, cyclohexylphenyldimethoxysilane, diphenyldimethoxysilane, phenylmethyldimethoxysilane, phenylisopropyldimethoxysilane, phenylisobutyldimethoxysilane, phenyl-tert-butyldimethoxysilane, phenylcyclopentyldimethoxysilane, 2-norbornanemethyldimethoxysilane, bis(perhydroquinoline)dimethoxysilane, bis(perhydroisoquinoline)dimethoxysilane, (perhydroquinolino)(perhydroisoquinolino)dimethoxysilane, (perhydroquinolino)methyldimethoxysilane, (perhydroisoquinolino)methyldimethoxysilane, (perhydroquinolino)ethyldimethoxysilane, (perhydroisoquinolino)ethyldimethoxysilane, (perhydroquinolino)(n-propyl)dimethoxysilane, (perhydroisoquinolino)(n-propyl)dimethoxysilane, (perhydroquinolino)(tert-butyl)dimethoxysilane, and (perhydroisoquinolino)(tert-butyl)dimethoxysilane. Among them, preferred is di-tert-butyldimethoxysilane, tert-butylmethyldimethoxysilane, tert-butylethyldimethoxysilane, tert-butyl-n-propyldimethoxysilane, tert-butyl-n-butyldimethoxysilane, tert-amylmethyldimethoxysilane, tert-amylethyldimethoxysilane, tert-amyl-n-propyldimethoxysilane, tert-amyl-n-butyldimethoxysilane, isobutylisopropyldimethoxysilane, tert-butylisopropyldimethoxysilane, dicyclobutyldimethoxysilane, cyclobutylisopropyldimethoxysilane, cyclobutylisobutyldimethoxysilane, cyclobutyl-tert-butyldimethoxysilane, dicyclopentyldimethoxysilane, cyclopentylisopropyldimethoxysilane, cyclopentylisobutyldimethoxysilane, cyclopentyl-tert-butyldimethoxysilane, dicyclohexyldimethoxysilane, cyclohexylmethyldimethoxysilane, cyclohexylethyldimethoxysilane, cyclohexylisopropyldimethoxysilane, cyclohexylisobutyldimethoxysilane, cyclohexyl-tert-butyldimethoxysilane, or cyclohexylcyclopentyldimethoxysilane, from a viewpoint of polymerization activity of a polymerization catalyst and stereoregularity of a polymer obtained.

The optional external electron donor in the pre-polymerization is used in an amount of generally 0.01 to 400 mol, preferably 0.02 to 200 mol, and particularly preferably 0.03 to 100 mol, per one mol of titanium atoms contained in the solid catalyst component used in the pre-polymerization, and is used in an amount of generally 0.003 to 5 mol, preferably 0.005 to 3 mol, and particularly preferably 0.01 to 2 mol, per one mol of the organoaluminum compound used in the pre-polymerization.

The external electron donor in the pre-polymerization is supplied to a pre-polymerization reactor according to the below-exemplified method (i) or (ii):

(i) a method of feeding independently the external electron donor to a pre-polymerization reactor; or

(ii) a method of feeding a contact product of the external electron donor with the organoaluminum compound to a pre-polymerization reactor.

Examples of the α-olefins used in the main polymerization are those having 3 to 20 carbon atoms. Examples thereof are propylene, 1-butene, 1-pentene, 1-hexene, 1-heptene, 1-octene, 1-nonene, 1-decene, 1-undecene, 1-dodecene, 1-hexadecene, 1-octadecene, and 4-methyl-1-pentene; and combinations of two or more thereof.

Those α-olefins may be combined with comonomers, which can polymerize with those α-olefins. Examples of the comonomers are ethylene and diolefin compounds. Examples of the diolefin compounds are conjugated dienes and non-conjugated dienes. Examples of the conjugated dienes are 1,3-butadiene, isoprene, 1,3-hexadinene, 1,3-octadiene, 1,3-cyclooctadiene, and 1,3-cyclohexadiene. Examples of the non-conjugated dienes are 1,4-pentadiene, 1,5-hexadiene, 1,6-hexadiene, 1,7-octadiene, 1,8-nonadiene, 1,9-decadiene, 1,10-undecadiene, 1,11-dodecadiene, 1,13-tetradecadiene, divinylbenzene, 4-methyl-1,4-hexadiene, 5-methyl-1,4-hexadiene, 7-methyl-1,6-octadiene, 5-ethylidene-2-norbornene, dicyclopentadiene, 5-vinyl-2-norbornene, 5-methyl-2-norbornene, norbornadiene, 5-methylene-2-norbornene, 1,5-cyclooctadiene, 5,8-endomethylenehexahydronaphthalene, and 1,2,4-trivinylcyclohexane.

Examples of α-olefin polymers produced according to the production process of the present invention are propylene homopolymers, 1-butene homopolymers, propylene-ethylene copolymers, propylene-1-butene copolymers, propylene-1-hexene copolymers, and propylene-1-octene copolymers.

The process for producing α-olefin polymers of the present invention is preferable for producing isotactic stereoregular α-olefin polymers, and particularly preferable for producing isotactic stereoregular propylene polymers.

Examples of the isotactic stereoregular propylene polymers are propylene homopolymers; copolymers of propylene with ethylene and/or comonomers such as α-olefins having 4 to 12 carbon atoms, wherein ethylene and/or the comonomers are used in an amount such that obtained copolymers have a crystalline property; and block copolymers obtained according to a production process comprising the steps of (i) homo-polymerizing propylene, or copolymerizing propylene with ethylene or α-olefins having 4 to 12 carbon atoms, this polymerization step being referred to hereinafter as “former polymerization step”, and (ii) copolymerizing ethylene with α-olefins having 3 to 12 carbon atoms, according to a mono-step polymerization method or a multi-step polymerization method, in the presence of polymers produced in the former polymerization step, this polymerization step being hereinafter referred to as “latter polymerization step”. The above term “block copolymer”, which is often used by those skilled in the art belonging to the technical field of the present invention, does not mean a true block copolymer as shown in authoritative documents such as chemical schoolbooks, but means a polymer blend of polymers produced in the former polymerization step (i) with polymers produced in the former polymerization step (ii). The above “amount such that obtained copolymers have a crystalline property” depends on the type of the comonomers. For example, when a comonomer is ethylene, ethylene is used in an amount such that obtained copolymers contain ethylene polymerization units in an amount of usually 10% by weight or less, and when a comonomer is α-olefins such as 1-butene, the α-olefins are used in an amount such that obtained copolymers contain α-olefin polymerization units in an amount of usually 30% by weight or less, and preferably 10% by weight or less, the total of the obtained copolymers being 100% by weight. On the other hand, the copolymers produced in the former polymerization step (i) contain comonomer polymerization units in respective amounts, for example, when the comonomer is ethylene, the copolymers contain ethylene polymerization units in an amount of usually 10% by weight or less, preferably 3% by weight or less, and further preferably 0.5% by weight or less, and when the comonomer is α-olefins, the copolymers contain α-olefin polymerization units in an amount of usually 15% by weight or less, and preferably 10% by weight or less, the total of the obtained copolymers being 100% by weight. The copolymers produced in the latter polymerization step (ii) contain ethylene polymerization units in an amount of usually 20 to 80% by weight, and preferably 20 to 50% by weight, the total of the obtained copolymers being 100% by weight.

The above-mentioned “isotactic stereoregularity” is shown usually by an index “isotactic pentad fraction”. The isotactic pentad fraction means a fraction of isotactic chains having pentad units contained in molecular chains of crystalline α-olefin polymers (for example, polypropylene). In other words, it means a fraction of α-olefin units existing at a center of a continuously meso-bonded chain consisting of five α-olefin units. The isotactic pentad fraction can be measured according to a ¹³C-NMR-utilizing method disclosed in Macromolecules No. 6, pages 925-926 (1973), authored by A. Zambelli, et al. In the present invention, however, an assignment of absorption peaks of ¹³C-NMR spectrums is based on Macromolecules No. 8, pages 687-689 (1975), published later than the above document. The isotactic pentad fraction may be referred to hereinafter as “mmmm %”, which has a theoretical upper limit of 1.00. The process for producing α-olefin polymers of the present invention is suitable for producing isotactic stereoregular α-olefin polymers having an mmmm % value of preferably 0.900 or more, more preferably 0.940 or more, and further preferably 0.955 or more.

The organoaluminum compound in the main polymerization is used in an amount of usually 1 to 10,000 mol, and particularly preferably 5 to 6,000 mol, per one mol of titanium atoms contained in the solid catalyst component used in the main polymerization.

The external electron donor in the main polymerization is used in an amount of usually 0.1 to 2,000 mol, preferably 0.3 to 1,000 mol, and particularly preferably 0.5 to 800 mol, per one mol of titanium atoms contained in the solid catalyst component used in the main polymerization, or is used in an amount of usually 0.001 to 5 mol, preferably 0.005 to 3 mol, and particularly preferably 0.01 to 1 mol, per one mol of the organoaluminum compound used in the main polymerization.

The main polymerization is carried out (1) at usually −30 to 300° C., and preferably 20 to 180° C., (2) under a pressure, which is not particularly limited, of usually an atmospheric pressure to 10 MPa, and preferably 200 kPa to 5 MPa, from an industrial and economical point of view, (3) according to a batchwise or continuous method, and (4) according to (i) a slurry or solution polymerization method with inert hydrocarbon solvents such as propane, butane, isobutane, pentane, hexane, heptane and octane, (ii) a bulk polymerization method using an olefin as a solvent, which olefin is liquid at a polymerization temperature, or (iii) a gas-phase polymerization method.

The process for producing α-olefin polymers of the present invention may contain one or more other polymerization steps than the main polymerization step, wherein the one or more other polymerization steps may have different polymerization conditions from those in the main polymerization step. The polymerization steps in the present invention use one or more polymerization reactors arranged in series or in parallel. Also, polymerization conditions may be changed continuously in respective polymerization reactors.

In order to control a molecular weight of polymers obtained in the main polymerization, there may be used chain transfer agents such as hydrogen and alkyl zincs (for example, dimethyl zinc and diethyl zinc).

According to the present invention, there can be obtained highly active α-olefin polymerization catalysts excellent in their molecular weight regulation by use of hydrogen gas, and highly stereoregular α-olefin polymers.

### EXAMPLE

The present invention is explained in more detail with reference to the following Examples, which do not limit the present invention.

### Example 1

A 300-liter stainless steel autoclave equipped with an agitator was dried under reduced pressure, and then was purged with argon gas. The autoclave was cooled, and then evacuated. To a glass charger containing heptane, there were charged 2.6 mmol of triethylaluminum (organoaluminum compound), 0.52 mmol of cyclohexyltriethoxysilane (external electron donor), and 6.39 mg of a solid catalyst component prepared according to JP 2004-182981A, Example 1(2), in this order, thereby contacting them with one another in the glass charger to form a mixture containing a polymerization catalyst.

The mixture was charged to the autoclave all at once. Then, 780 g of liquefied propylene (α-olefin) and 5.1 NL of hydrogen were charged to the autoclave in this order. The autoclave was heated up to 70° C., thereby initiating polymerization.

After the polymerization for one hour, unreacted propylene remaining in the autoclave was purged to obtain a polymer. The polymer was dried at 60° C. for one hour under reduced pressure, thereby obtaining 166 g of a propylene homopolymer powder. A yield of the propylene homopolymer per one gram of the solid catalyst component was 26,000 g-polymer/g-solid catalyst component (polymerization activity).

The propylene homopolymer was found to have 0.78% by weight of soluble parts in xylene at 20° C. (CXS); an intrinsic viscosity ([η]) of 1.08 dl/g; and an isotactic pentad fraction [mmmm] of 0.9783, the total of the homopolymer being 100% by weight. Results are summarized in Table 1.

The above amount of soluble parts in xylene at 20° C., CXS, was measured according to a method comprising the steps of:

(i) adding 1 g of the polymer to 200 ml of boiling xylene, thereby obtaining a solution of the copolymer in xylene;

(ii) cooling the solution slowly down to 50° C.;

(iii) further cooling the solution down to 20° C. by dipping it in an iced water bath under agitation;

(iv) keeping the solution at 20° C. for 3 hours, thereby precipitating the polymer;

(v) filtering off the precipitated copolymer, thereby obtaining a filtrate;

(vi) distilling xylene contained in the filtrate away to dryness, thereby obtaining soluble parts;

(vii) weighing the soluble parts; and

(viii) calculating CXS based thereon.

Usually, the smaller CXS value the polymer has, the smaller amount of amorphous polymers the polymer contains, namely, the higher stereoregularity the polymer has.

The above intrinsic viscosity, [η], was measured according to a method comprising the steps of:

(1) measuring respective reduced viscosities of TETRALINE solutions having concentrations of 0.1 g/dl, 0.2 g/dl and 0.5 g/dl, at 135° C. with an Ubbellohde viscometer; and

(2) calculating an intrinsic viscosity according to a method described in “Kobunshi yoeki, Kobunshi jikkengaku 11” (published by Kyoritsu Shuppan Co. Ltd. in 1982), page 491, namely, by plotting those reduced viscosities for those concentrations, and then extrapolating the concentration to zero.

The above isotactic pentad fraction, [mmmm], was measured according to a method comprising the steps of:

(1) dissolving homogeneously about 200 mg of a sample polymer in 3 mL of o-dichlorobenzene in a 10 mm-Φ test tube;

(2) obtaining a ¹³C-NMR spectrum of the resultant solution under the following conditions,
measurement temperature 135° C.,
pulse repetition time 10 seconds,
pulse width 45°, and
cumulated number 2,500 times; and

(3) calculating an isotactic pentad fraction, [mmmm], based on the ¹³C-NMR spectrum, according to the above-mentioned method disclosed in Macromolecules No. 6, pages 925-926 (1973), authored by A. Zambelli, et al.

### Example 2

Example 1 was repeated except that (1) the amount of the solid catalyst component was changed to 5.44 mg, and (2) the amount of hydrogen charged was changed to 15.4 NL, thereby obtaining a propylene homopolymer powder. A yield of the propylene homopolymer per one gram of the solid catalyst component was 25,500 g-polymer/g-solid catalyst component (polymerization activity).

The propylene homopolymer was found to have 0.90% by weight of soluble parts in xylene at 20° C. (CXS); an intrinsic viscosity ([η]) of 0.75 dl/g; and an isotactic pentad fraction [mmmm] of 0.9829, the total of the homopolymer being 100% by weight. Results are summarized in Table 1.

### Example 3

Example 1 was repeated except that (1) the amount of the solid catalyst component was changed to 8.47 mg, and (2) the external electron donor was changed to 0.52 mmol of cyclopentyltriethoxysilane, thereby obtaining a propylene homopolymer powder. A yield of the propylene homopolymer per one gram of the solid catalyst component was 28,700 g-polymer/g-solid catalyst component (polymerization activity).

The propylene homopolymer was found to have 0.72% by weight of soluble parts in xylene at 20° C. (CXS); an intrinsic viscosity ([η]) of 1.10 dl/g; and an isotactic pentad fraction [mmmm] of 0.9805, the total of the homopolymer being 100% by weight. Results are summarized in Table 1.

### Example 4

Example 1 was repeated except that (1) the amount of the solid catalyst component was changed to 8.94 mg, (2) the external electron donor was changed to 0.52 mmol of cyclopentyltriethoxysilane, and (3) the amount of hydrogen charged was changed to 15.4 NL, thereby obtaining a propylene homopolymer powder. A yield of the propylene homopolymer per one gram of the solid catalyst component was 24,700 g-polymer/g-solid catalyst component (polymerization activity).

The propylene homopolymer was found to have 0.73% by weight of soluble parts in xylene at 20° C. (CXS); an intrinsic viscosity ([η]) of 0.78 dl/g; and an isotactic pentad fraction [mmmm] of 0.9830, the total of the homopolymer being 100% by weight. Results are summarized in Table 1.

### Example 5

Example 1 was repeated except that (1) the amount of the solid catalyst component was changed to 8.61 mg, (2) the external electron donor was changed to 1.05 mmol of sec-butyltriethoxysilane, and (3) the amount of hydrogen charged was changed to 15.4 NL, thereby obtaining a propylene homopolymer powder. A yield of the propylene homopolymer per one gram of the solid catalyst component was 23,500 g-polymer/g-solid catalyst component (polymerization activity).

The propylene homopolymer was found to have 0.90% by weight of soluble parts in xylene at 20° C. (CXS); an intrinsic viscosity ([η]) of 0.72 dl/g; and an isotactic pentad fraction [mmmm] of 0.9823, the total of the homopolymer being 100% by weight. Results are summarized in Table 1.

### Comparative Example 1

Example 1 was repeated except that (1) the amount of the solid catalyst component was changed to 6.12 mg, and (2) the external electron donor was changed to 0.52 mmol of cyclohexylethyldimethoxysilane, thereby obtaining a propylene homopolymer powder. A yield of the propylene homopolymer per one gram of the solid catalyst component was 29,400 g-polymer/g-solid catalyst component (polymerization activity).

The propylene homopolymer was found to have 0.63% by weight of soluble parts in xylene at 20° C. (CXS); an intrinsic viscosity ([η]) of 1.36 dl/g; and an isotactic pentad fraction [mmmm] of 0.9806, the total of the homopolymer being 100% by weight. Results are summarized in Table 1.

### Comparative Example 2

Example 1 was repeated except that (1) the amount of the solid catalyst component was changed to 6.99 mg, (2) the external electron donor was changed to 0.52 mmol of cyclohexylethyldimethoxysilane, (3) the amount of hydrogen charged was changed to 15.4 NL, thereby obtaining a propylene homopolymer powder. A yield of the propylene homopolymer per one gram of the solid catalyst component was 26,000 g-polymer/g-solid catalyst component (polymerization activity).

The propylene homopolymer was found to have 0.77% by weight of soluble parts in xylene at 20° C. (CXS); an intrinsic viscosity ([η]) of 0.93 dl/g; and an isotactic pentad fraction [mmmm] of 0.9825, the total of the homopolymer being 100% by weight. Results are summarized in Table 1.

### Example 6

A 300-liter stainless steel autoclave equipped with an agitator was dried under reduced pressure, and then was purged with argon gas. The autoclave was cooled, and then evacuated. To a glass charger containing heptane, there were charged 2.6 mmol of triethylaluminum (organoaluminum compound), 0.52=1 of cyclohexyltriethoxysilane (external electron donor), 0.26 mmol of 1,3-dioxolan as an optional compound having a bond, —C—O—C—O—C, and 8.39 mg of a solid catalyst component prepared according to JP 2004-182981A, Example 1(2), in this order, thereby contacting them with one another in the glass charger to form a mixture containing a polymerization catalyst.

The mixture was charged to the autoclave all at once. Then, 780 g of liquefied propylene (α-olefin) and 15.4 NL of hydrogen were charged to the autoclave in this order. The autoclave was heated up to 70° C., thereby initiating polymerization.

After the polymerization for one hour, unreacted propylene remaining in the autoclave was purged to obtain a polymer. The polymer was dried at 60° C. for one hour under reduced pressure, thereby obtaining 159 g of a propylene homopolymer powder. A yield of the propylene homopolymer per one gram of the solid catalyst component was 19,000 g-polymer/g-solid catalyst component (polymerization activity).

The propylene homopolymer was found to have 0.80% by weight of soluble parts in xylene at 20° C. (CXS); an intrinsic viscosity ([η]) of 0.72 dl/g; and an isotactic pentad fraction [mmmm] of 0.9852, the total of the homopolymer being 100% by weight. Results are summarized in Table 1.

### Example 7

Example 6 was repeated except that (1) the amount of the solid catalyst component was changed to 8.62 mg, and (2) the amount of 1,3-dioxolan was changed to 0.18 mmol, thereby obtaining a propylene homopolymer powder. A yield of the propylene homopolymer per one gram of the solid catalyst component was 20,400 g-polymer/g-solid catalyst component (polymerization activity).

The propylene homopolymer was found to have 0.80% by weight of soluble parts in xylene at 20° C. (CXS); an intrinsic viscosity ([η]) of 0.79 dl/g; and an isotactic pentad fraction [mmmm] of 0.9887, the total of the homopolymer being 100% by weight. Results are summarized in Table 1.

### Example 8

Example 6 was repeated except that (1) the amount of the solid catalyst component was changed to 5.82 mg, and (2) the external electron donor was changed to 0.52 mmol of cyclopentyltriethoxysilane, thereby obtaining a propylene homopolymer powder. A yield of the propylene homopolymer per one gram of the solid catalyst component was 18,500 g-polymer/g-solid catalyst component (polymerization activity).

The propylene homopolymer was found to have 0.60% by weight of soluble parts in xylene at 20° C. (CXS); an intrinsic viscosity ([η]) of 0.80 dl/g; and an isotactic pentad fraction [mmmm] of 0.9832, the total of the homopolymer being 100% by weight. Results are summarized in Table 1.

### Example 9

Example 6 was repeated except that (1) the amount of the solid catalyst component was changed to 10.6 mg, and (2) the external electron donor was changed to 1.05 mmol of sec-butyltriethoxysilane, thereby obtaining a propylene homopolymer powder. A yield of the propylene homopolymer per one gram of the solid catalyst component was 16,100 g-polymer/g-solid catalyst component (polymerization activity).

The propylene homopolymer was found to have 0.70% by weight of soluble parts in xylene at 20° C. (CXS); an intrinsic viscosity ([η]) of 0.73 dl/g; and an isotactic pentad fraction [mmmm] of 0.9841, the total of the homopolymer being 100% by weight. Results are summarized in Table 1.

As explained above, the α-olefin polymerization catalysts utilized in Examples 1 to 9 gave propylene homopolymers having a lower intrinsic viscosity under the same amount of hydrogen gas, and were more excellent in their balance between a polymerization activity and a stereoregularity, than the α-olefin polymerization catalysts utilized in Comparative Examples 1 and 2. Namely, according to the production process of an α-olefin polymerization catalyst of the present invention, there can be obtained a highly active α-olefin polymerization catalyst excellent in its molecular weight regulation by use of hydrogen gas, and according to the production process of an α-olefin polymer of the present invention, there can be obtained a highly stereoregular α-olefin polymer.

TABLE 1

| | Example | | | | | |
|---|---|---|---|---|---|---|
| | 1 | 2 | 3 | 4 | 5 | 6 |
| Electron donor: | | | | | | |
| Kind*¹ | CHTES | CHTES | CPTES | CPTES | sBTES | CHTES |
| Amount*² | 0.2 | 0.2 | 0.2 | 0.2 | 0.4 | 0.2 |
| Compound having —C—O—C—O—C—bond: | | | | | | |
| Kind*³ | — | — | — | — | — | DOX |
| Amount*⁴ | — | — | — | — | — | 0.1 |
| Hydrogen amount (NL) | 5.1 | 15.4 | 5.1 | 15.4 | 15.4 | 15.4 |
| Result: | | | | | | |
| Polymerization activity*⁵ | 26000 | 25500 | 28700 | 24700 | 23500 | 19000 |
| CXS (we %) | 0.78 | 0.90 | 0.72 | 0.73 | 0.90 | 0.80 |
| [η] (dl/g) | 1.08 | 0.75 | 1.10 | 0.78 | 0.72 | 0.72 |
| [mmmm] | 0.9783 | 0.9829 | 0.9805 | 0.9830 | 0.9823 | 0.9852 |

| | | | | Comparative | |
|---|---|---|---|---|---|
| | Example | | | Example | |
| | 7 | 8 | 9 | 1 | 2 |
| Electron donor: | | | | | |
| Kind*¹ | CHTES | CPTES | sBTES | CHEDMS | CHEDMS |
| Amount*² | 0.2 | 0.2 | 0.4 | 0.2 | 0.2 |
| Compound having —C—O—C—O—C—bond: | | | | | |
| Kind*³ | DOX | DOX | DOX | — | — |
| Amount*⁴ | 0.07 | 0.1 | 0.1 | — | — |
| Hydrogen amount (NL) | 15.4 | 15.4 | 15.4 | 5.1 | 15.4 |
| Result: | | | | | |
| Polymerization activity*⁵ | 20400 | 18500 | 16100 | 29400 | 26000 |
| CXS (we %) | 0.80 | 0.60 | 0.70 | 0.63 | 0.77 |
| [η] (dl/g) | 0.79 | 0.80 | 0.73 | 1.36 | 0.93 |
| [mmmm] | 0.9857 | 0.9832 | 0.9841 | 0.9806 | 0.9825 |

*¹CHTES: cyclohexyltriethoxysilane
CPTES: cyclopentyltriethoxysilane
sBTES: sec-butyltriethoxysilane
CHEDMS: cyclohexylethyldimethoxysilane
*²Molar ratio of electron donor to organoaluminum compound
*³DOX: 1,3-dioxolan
*⁴Molar ratio of compound having —C—O—C—O—C— bond to organoaluminum compound
*⁵Yield of polymer per one gram of solid catalyst component (g-polymer/g-solid catalyst component)

### Example 10

### Preparation of Pre-Polymerized Solid Catalyst Component

To a 300-ml round-bottomed glass flask equipped with an agitator, 100 ml of dewatered and degassed heptane was charged under agitating. The flask was cooled so as to keep the heptane temperature at 2 to 5° C. To the flask, there were charged 2.7 mmol of triethylaluminum, 0.27 mmol of cyclohexyltriethoxysilane (external electron donor), and 1.70 g of a solid catalyst component prepared according to JP 2004-182981A, Example 1(2), in this order, thereby forming a mixture. While keeping the mixture temperature at 2 to 5° C., 3.8 g of propylene was supplied continuously to the flask over about 3 minutes, thereby pre-polymerizing propylene. Then, 150 ml of heptane was added to the flask, thereby obtaining a slurry of the pre-polymerized solid catalyst component. In order to calculate an amount of pre-polymerized propylene, the slurry was filtered, and the separate pre-polymerized solid catalyst component was washed two times with each 100 ml of hexane. The washed pre-polymerized solid catalyst component was dried at room temperature under reduced pressure, thereby obtaining 6.60 g of the dried pre-polymerized solid catalyst component. Therefore, an amount of polypropylene contained in the pre-polymerized solid catalyst component was calculated to be 0.75 g-polypropylene/g-pre-polymerized solid catalyst component. The above slurry was found to contain 0.026 g of the pre-polymerized solid catalyst component per one ml of the slurry.

### Main Polymerization

A 300-liter stainless steel autoclave equipped with an agitator was dried under reduced pressure, and then was purged with argon gas. The autoclave was cooled, and then evacuated. There were charged 1.5 mmol of triethylaluminum and 0.52 mmol of cyclohexyltriethoxysilane (external electron donor), in this order, to a glass charger containing 20 ml of heptane, thereby forming a mixture.

The mixture was charged to the autoclave all together. Then, 780 g of liquefied propylene (α-olefin) and 5.1 NL of hydrogen were charged to the autoclave in this order. The autoclave was heated up to 70° C. There were charged 0.5 mmol of triethylaluminum and 1 ml of the above slurry of the pre-polymerized solid catalyst component, in this order, to a high-pressure injector containing 30 ml of heptane, thereby forming a mixture.

The mixture was pressed into the autoclave all together with argon gas, thereby polymerizing for one hour (main polymerization). After the polymerization, unreacted propylene remaining in the autoclave was purged to obtain a polymer. The polymer was dried at 60° C. for one hour under reduced pressure, thereby obtaining 288 g of a propylene homopolymer powder. A yield of the propylene homopolymer per one gram of the solid catalyst component was 42,500 g-polymer/g-solid catalyst component (polymerization activity).

The propylene homopolymer was found to have 0.91% by weight of soluble parts in xylene at 20° C. (CXS); an intrinsic viscosity ([η]) of 1.16 dl/g; and an isotactic pentad fraction [mmmm] of 0.9770, the total of the homopolymer being 100% by weight. Results are summarized in Table 2.

### Example 11

### Preparation of Pre-Polymerized Solid Catalyst Component

Example 10 was repeated except that the amount of the solid catalyst component was changed to 1.92 g, thereby obtaining 7.79 g of the dried pre-polymerized solid catalyst component. Therefore, an amount of polypropylene contained in the pre-polymerized solid catalyst component was calculated to be 0.76 g-polypropylene/g-pre-polymerized solid catalyst component. The slurry was found to contain 0.031 g of the pre-polymerized solid catalyst component per one ml of the slurry.

### Main Polymerization

Example 10 was repeated except that (1) 1 ml of the above slurry of the pre-polymerized solid catalyst component was used, and (2) the amount of hydrogen was changed to 15.4 NL, thereby obtaining a propylene homopolymer powder. A yield of the propylene homopolymer per one gram of the solid catalyst component was 51,700 g-polymer/g-solid catalyst component (polymerization activity).

The propylene homopolymer was found to have 0.87% by weight of soluble parts in xylene at 20° C. (CXS); an intrinsic viscosity ([η]) of 0.79 dl/g; and an isotactic pentad fraction [mmmm] of 0.9823, the total of the homopolymer being 100% by weight. Results are summarized in Table 2.

### Example 12

### Preparation of Pre-Polymerized Solid Catalyst Component

Example 10 was repeated except that (1) the amount of the solid catalyst component was changed to 1.87 g, and (2) the external electron donor was changed to 0.27 mmol of cyclohexylethyldimethoxysilane, thereby obtaining 7.84 g of the dried pre-polymerized solid catalyst component. Therefore, an amount of polypropylene contained in the pre-polymerized solid catalyst component was calculated to be 0.77 g-polypropylene/g-pre-polymerized solid catalyst component. The slurry was found to contain 0.031 g of the pre-polymerized solid catalyst component per one ml of the slurry.

### Main Polymerization

Example 10 was repeated except that 1 ml of the above slurry of the pre-polymerized solid catalyst component was used, thereby obtaining a propylene homopolymer powder. A yield of the propylene homopolymer per one gram of the solid catalyst component was 58,500 g-polymer/g-solid catalyst component (polymerization activity).

The propylene homopolymer was found to have 0.72% by weight of soluble parts in xylene at 20° C. (CXS); an intrinsic viscosity ([η]) of 1.12 dl/g; and an isotactic pentad fraction [mmmm] of 0.9810, the total of the homopolymer being 100% by weight. Results are summarized in Table 2.

### Example 13

### Preparation of Pre-Polymerized Solid Catalyst Component

Example 10 was repeated except that (1) the amount of the solid catalyst component was changed to 1.66 g, and (2) the external electron donor was changed to 0.27 mmol of cyclohexylethyldimethoxysilane, thereby obtaining 8.87 g of the dried pre-polymerized solid catalyst component. Therefore, an amount of polypropylene contained in the pre-polymerized solid catalyst component was calculated to be 0.82 g-polypropylene/g-pre-polymerized solid catalyst component. The slurry was found to contain 0.035 g of the pre-polymerized solid catalyst component per one ml of the slurry.

### Main Polymerization

Example 10 was repeated except that (1) 1 ml of the above slurry of the pre-polymerized solid catalyst component was used, and (2) the amount of hydrogen was changed to 15.4 NL, thereby obtaining a propylene homopolymer powder. A yield of the propylene homopolymer per one gram of the solid catalyst component was 65,500 g-polymer/g-solid catalyst component (polymerization activity).

The propylene homopolymer was found to have 0.86% by weight of soluble parts in xylene at 20° C. (CXS); an intrinsic viscosity ([η]) of 0.85 dl/g; and an isotactic pentad fraction [mmmm] of 0.9851, the total of the homopolymer being 100% by weight. Results are summarized in Table 2.

### Example 14

### Preparation of Pre-Polymerized Solid Catalyst Component

Example 10 was repeated except that (1) the amount of the solid catalyst component was changed to 1.98 g, and (2) the external electron donor was changed to 0.27 mmol of cyclohexylethyldimethoxysilane, thereby obtaining 9.10 g of the dried pre-polymerized solid catalyst component. Therefore, an amount of polypropylene contained in the pre-polymerized solid catalyst component was calculated to be 0.79 g-polypropylene/g-pre-polymerized solid catalyst component. The slurry was found to contain 0.036 g of the pre-polymerized solid catalyst component per one ml of the slurry.

### Main Polymerization

Example 10 was repeated except that (1) 1 ml of the above slurry of the pre-polymerized solid catalyst component was used, and (2) the external electron donor was changed to 0.52 mmol of cyclopentyltriethoxysilane, thereby obtaining a propylene homopolymer powder. A yield of the propylene homopolymer per one gram of the solid catalyst component was 47,400 g-polymer/g-solid catalyst component (polymerization activity).

The propylene homopolymer was found to have 0.64% by weight of soluble parts in xylene at 20° C. (CXS); an intrinsic viscosity ([η]) of 1.16 dl/g; and an isotactic pentad fraction [mmmm] of 0.9830, the total of the homopolymer being 100% by weight. Results are summarized in Table 2.

### Example 15

### Preparation of Pre-Polymerized Solid Catalyst Component

Example 10 was repeated except that (1) the amount of the solid catalyst component was changed to 1.90 g, and (2) the external electron donor was changed to 0.27 mmol of cyclohexylethyldimethoxysilane, thereby obtaining 8.28 g of the dried pre-polymerized solid catalyst component. Therefore, an amount of polypropylene contained in the pre-polymerized solid catalyst component was calculated to be 0.77 g-polypropylene/g-pre-polymerized solid catalyst component. The slurry was found to contain 0.033 g of the pre-polymerized solid catalyst component per one ml of the slurry.

### Main Polymerization

Example 10 was repeated except that (1) 1 ml of the above slurry of the pre-polymerized solid catalyst component was used, (2) the external electron donor was changed to 0.52 mmol of cyclopentyltriethoxysilane, and (3) the amount of hydrogen was changed to 15.4 NL, thereby obtaining a propylene homopolymer powder. A yield of the propylene homopolymer per one gram of the solid catalyst component was 49,700 g-polymer/g-solid catalyst component (polymerization activity).

The propylene homopolymer was found to have 0.82% by weight of soluble parts in xylene at 20° C. (CXS); an intrinsic viscosity ([η]) of 0.80 dl/g; and an isotactic pentad fraction [mmmm] of 0.9837, the total of the homopolymer being 100% by weight. Results are summarized in Table 2.

### Example 16

### Preparation of Pre-Polymerized Solid Catalyst Component

Example 10 was repeated except that (1) the amount of the solid catalyst component was changed to 1.85 g, and (2) the external electron donor was changed to 0.27 mmol of cyclohexylethyldimethoxysilane, thereby obtaining 7.31 g of the dried pre-polymerized solid catalyst component. Therefore, an amount of polypropylene contained in the pre-polymerized solid catalyst component was calculated to be 0.75 g-polypropylene/g-pre-polymerized solid catalyst component. The slurry was found to contain 0.029 g of the pre-polymerized solid catalyst component per one ml of the slurry.

### Main Polymerization

Example 10 was repeated except that (1) 1 ml of the above slurry of the pre-polymerized solid catalyst component was used, (2) the external electron donor was changed to 1.05 mmol of sec-butyltriethoxysilane, and (3) the amount of hydrogen was changed to 15.4 NL, thereby obtaining a propylene homopolymer powder. A yield of the propylene homopolymer per one gram of the solid catalyst component was 61,500 g-polymer/g-solid catalyst component (polymerization activity).

The propylene homopolymer was found to have 1.00% by weight of soluble parts in xylene at 20° C. (CXS); an intrinsic viscosity ([η]) of 0.78 dl/g; and an isotactic pentad fraction [mmmm] of 0.9815, the total of the homopolymer being 100% by weight. Results are summarized in Table 2.

### Comparative Example 3

### Preparation of Pre-Polymerized Solid Catalyst Component

Example 10 was repeated except that (1) the amount of the solid catalyst component was changed to 1.78 g, and (2) the external electron donor was changed to 0.27 mmol of cyclohexylethyldimethoxysilane, thereby obtaining 7.25 g of the dried pre-polymerized solid catalyst component. Therefore, an amount of polypropylene contained in the pre-polymerized solid catalyst component was calculated to be 0.76 g-polypropylene/g-pre-polymerized solid catalyst component. The slurry was found to contain 0.029 g of the pre-polymerized solid catalyst component per one ml of the slurry.

### Main Polymerization

Example 10 was repeated except that (1) 1 ml of the above slurry of the pre-polymerized solid catalyst component was used, and (2) the external electron donor was changed to 0.52 mmol of cyclohexylethyldimethoxysilane, thereby obtaining a propylene homopolymer powder. A yield of the propylene homopolymer per one gram of the solid catalyst component was 42,800 g-polymer/g-solid catalyst component (polymerization activity).

The propylene homopolymer was found to have 0.59% by weight of soluble parts in xylene at 20° C. (CXS); an intrinsic viscosity ([η]) of 1.33 dl/g; and an isotactic pentad fraction [mmmm] of 0.9824, the total of the homopolymer being 100% by weight. Results are summarized in Table 2.

### Comparative Example 4

### Preparation of Pre-Polymerized Solid Catalyst Component

Example 10 was repeated except that (1) the amount of the solid catalyst component was changed to 1.62 g, and (2) the external electron donor was changed to 0.27 mmol of cyclohexylethyldimethoxysilane, thereby obtaining 7.06 g of the dried pre-polymerized solid catalyst component. Therefore, an amount of polypropylene contained in the pre-polymerized solid catalyst component was calculated to be 0.78 g-polypropylene/g-pre-polymerized solid catalyst component. The slurry was found to contain 0.028 g of the pre-polymerized solid catalyst component per one ml of the slurry.

### Main Polymerization

Example 10 was repeated except that (1) 1 ml of the above slurry of the pre-polymerized solid catalyst component was used, (2) the external electron donor was changed to 0.52 mmol of cyclohexylethyldimethoxysilane, and (3) the amount of hydrogen was changed to 15.4 NL, thereby obtaining a propylene homopolymer powder. A yield of the propylene homopolymer per one gram of the solid catalyst component was 46,000 g-polymer/g-solid catalyst component (polymerization activity).

The propylene homopolymer was found to have 0.85% by weight of soluble parts in xylene at 20° C. (CXS); an intrinsic viscosity ([η]) of 1.05 dl/g; and an isotactic pentad fraction [mmmm] of 0.9819, the total of the homopolymer being 100% by weight. Results are summarized in Table 2.

### Example 17

### Preparation of Pre-Polymerized Solid Catalyst Component

Example 10 was repeated except that (1) the amount of the solid catalyst component was changed to 1.84 g, and (2) the external electron donor was changed to 0.27 mmol of cyclohexylethyldimethoxysilane, thereby obtaining 8.29 g of the dried pre-polymerized solid catalyst component. Therefore, an amount of polypropylene contained in the pre-polymerized solid catalyst component was calculated to be 0.78 g-polypropylene/g-pre-polymerized solid catalyst component. The slurry was found to contain 0.033 g of the pre-polymerized solid catalyst component per one ml of the slurry.

### Main Polymerization

A 300-liter stainless steel autoclave equipped with an agitator was dried under reduced pressure, and then was purged with argon gas. The autoclave was cooled, and then evacuated. There were charged 1.5 mmol of triethylaluminum, 0.52 mmol of cyclohexyltriethoxysilane (external electron donor), and 0.085 mmol of 1,3-dioxolan as an optional compound having a bond, —C—O—C—O—C—, in this order, to a glass charger containing 20 ml of heptane, thereby forming a mixture.

The mixture was charged to the autoclave all together. Then, 780 g of liquefied propylene (α-olefin) and 15.4 NL of hydrogen were charged to the autoclave in this order. The autoclave was heated up to 70° C. There were charged 0.5 mmol of triethylaluminum and 1 ml of the above slurry of the pre-polymerized solid catalyst component, in this order, to a high-pressure injector containing 30 ml of heptane, thereby forming a mixture.

The mixture was pressed into the autoclave all together with argon gas, thereby polymerizing for one hour (main polymerization). After the polymerization, unreacted propylene remaining in the autoclave was purged to obtain a polymer. The polymer was dried at 60° C. for one hour under reduced pressure, thereby obtaining 306 g of a propylene homopolymer powder. A yield of the propylene homopolymer per one gram of the solid catalyst component was 41,700 g-polymer/g-solid catalyst component (polymerization activity).

The propylene homopolymer was found to have 0.77% by weight of soluble parts in xylene at 20° C. (CXS); an intrinsic viscosity ([η]) of 0.81 dl/g; and an isotactic pentad fraction [mmmm] of 0.9855, the total of the homopolymer being 100% by weight. Results are summarized in Table 3.

### Example 18

### Preparation of Pre-Polymerized Solid Catalyst Component

Example 10 was repeated except that the amount of the solid catalyst component was changed to 1.86 g, thereby obtaining 6.57 g of the dried pre-polymerized solid catalyst component. Therefore, an amount of polypropylene contained in the pre-polymerized solid catalyst component was calculated to be 0.72 g-polypropylene/g-pre-polymerized solid catalyst component. The slurry was found to contain 0.026 g of the pre-polymerized solid catalyst component per one ml of the slurry.

### Main Polymerization

Example 17 was repeated except that (1) 1 ml of the above slurry of the pre-polymerized solid catalyst component was used, and (2) the amount of 1,3-dioxolan was changed to 0.26 mmol, thereby obtaining a propylene homopolymer powder. A yield of the propylene homopolymer per one gram of the solid catalyst component was 37,300 g-polymer/g-solid catalyst component (polymerization activity).

The propylene homopolymer was found to have 0.65% by weight of soluble parts in xylene at 20° C. (CXS); an intrinsic viscosity ([η]) of 0.81 dl/g; and an isotactic pentad fraction [mmmm] of 0.9856, the total of the homopolymer being 100% by weight. Results are summarized in Table 3.

### Example 19

### Preparation of Pre-Polymerized Solid Catalyst Component

Example 10 was repeated except that the amount of the solid catalyst component was changed to 2.00 g, thereby obtaining 8.82 g of the dried pre-polymerized solid catalyst component. Therefore, an amount of polypropylene contained in the pre-polymerized solid catalyst component was calculated to be 0.78 g-polypropylene/g-pre-polymerized solid catalyst component. The slurry was found to contain 0.035 g of the pre-polymerized solid catalyst component per one ml of the slurry.

### Main Polymerization

Example 17 was repeated except that (1) 1 ml of the above slurry of the pre-polymerized solid catalyst component was used, (2) the external electron donor was changed to 0.52 mmol of cyclopentyltriethoxysilane, and (3) the amount of 1,3-dioxolan was changed to 0.26 mmol, thereby obtaining a propylene homopolymer powder. A yield of the propylene homopolymer per one gram of the solid catalyst component was 39,500 g-polymer/g-solid catalyst component (polymerization activity).

The propylene homopolymer was found to have 0.59% by weight of soluble parts in xylene at 20° C. (CXS); an intrinsic viscosity ([η]) of 0.82 dl/g; and an isotactic pentad fraction [mmmm] of 0.9858, the total of the homopolymer being 100% by weight. Results are summarized in Table 3.

### Example 20

### Preparation of Pre-Polymerized Solid Catalyst Component

Example 10 was repeated except that the amount of the solid catalyst component was changed to 1.89 g, thereby obtaining 6.31 g of the dried pre-polymerized solid catalyst component. Therefore, an amount of polypropylene contained in the pre-polymerized solid catalyst component was calculated to be 0.70 g-polypropylene/g-pre-polymerized solid catalyst component. The slurry was found to contain 0.025 g of the pre-polymerized solid catalyst component per one ml of the slurry.

### Main Polymerization

Example 17 was repeated except that (1) 1 ml of the above slurry of the pre-polymerized solid catalyst component was used, (2) the external electron donor was changed to 1.05 mmol of sec-butyltriethoxysilane, and (3) the amount of 1,3-dioxolan was changed to 0.26 mmol, thereby obtaining a propylene homopolymer powder. A yield of the propylene homopolymer per one gram of the solid catalyst component was 38,000 g-polymer/g-solid catalyst component (polymerization activity).

The propylene homopolymer was found to have 0.81% by weight of soluble parts in xylene at 20° C. (CXS); an intrinsic viscosity ([η]) of 0.80 dl/g; and an isotactic pentad fraction [mmmm] of 0.9848, the total of the homopolymer being 100% by weight. Results are summarized in Table 3.

TABLE 2

| | Example | | | | | | | Comparative Example | |
|---|---|---|---|---|---|---|---|---|---|
| | 10 | 11 | 12 | 13 | 14 | 15 | 16 | 3 | 4 |
| Pre-polymerization | | | | | | | | | |
| Electron donor | | | | | | | | | |
| Kind*¹ | CHTES | CHTES | CHEDMS | CHEDMS | CHEDMS | CHEDMS | CHEDMS | CHEDMS | CHEDMS |
| Amount*² | 0.1 | 0.1 | 0.1 | 0.1 | 0.1 | 0.1 | 0.1 | 0.1 | 0.1 |
| Main | | | | | | | | | |
| polymerization | | | | | | | | | |
| Electron donor | | | | | | | | | |
| Kind*¹ | CHTES | CHTES | CHTES | CHTES | CPTES | CPTES | sBTES | CHEDMS | CHEDMS |
| Amount*² | 0.2 | 0.2 | 0.2 | 0.2 | 0.2 | 0.2 | 0.4 | 0.2 | 0.2 |
| 1,3-Dioxolan*² | — | — | — | — | — | — | — | — | — |
| Hydrogen (NL) | 5.1 | 15.4 | 5.1 | 15.4 | 5.1 | 15.4 | 15.4 | 5.1 | 15.4 |
| Polymer obtained | | | | | | | | | |
| Yield*⁴ | 42,500 | 51,700 | 58,500 | 65,500 | 47,400 | 49,700 | 61,500 | 42,800 | 46,000 |
| CXS (wt %) | 0.91 | 0.87 | 0.72 | 0.86 | 0.64 | 0.82 | 1.00 | 0.59 | 0.85 |
| [η] (dl/g) | 1.16 | 0.79 | 1.12 | 0.85 | 1.16 | 0.80 | 0.78 | 1.33 | 1.05 |
| [mmmm] | 0.9770 | 0.9823 | 0.9810 | 0.9851 | 0.9830 | 0.9837 | 0.9815 | 0.9824 | 0.9819 |

TABLE 3

| | Example | | | |
|---|---|---|---|---|
| | 17 | 18 | 19 | 20 |
| Pre-polymerization | | | | |
| Electron donor | | | | |
| Kind*¹ | CHEDMS | CHEDMS | CHEDMS | CHEDMS |
| Amount*² | 0.1 | 0.1 | 0.1 | 0.1 |
| Main polymerization | | | | |
| Electron donor | | | | |
| Kind*¹ | CHTES | CHTES | CPTES | sBTES |
| Amount*² | 0.2 | 0.2 | 0.2 | 0.4 |
| 1,3-Dioxolan*² | 0.03 | 0.1 | 0.1 | 0.1 |
| Hydrogen (NL) | 15.4 | 15.4 | 15.4 | 15.4 |
| Polymer obtained | | | | |
| Yield*³ | 41,700 | 37,300 | 39,500 | 38,000 |
| CXS (wt %) | 0.77 | 0.65 | 0.59 | 0.81 |
| [η] (dl/g) | 0.81 | 0.81 | 0.82 | 0.80 |
| [mmmm] | 0.9855 | 0.9856 | 0.9858 | 0.9848 |

*¹CHTES: cyclohexyltriethoxysilane CPTES: cyclopentyltriethoxysilane sBTES: sec-butyltriethoxysilane CHEDMS: cyclohexylethyldimethoxysilane
*²mol/mol-organoaluminum compound
*³g-polymer/g-solid catalyst component

1. A process for producing an α-olefin polymerization catalyst, comprising the steps of:
(1) reducing a titanium compound represented by the following formula (I) with an organomagnesium compound in the presence of an Si—O bond-containing silicon compound, thereby forming a solid catalyst component precursor;
(2) contacting the solid catalyst component precursor, a halogenating compound and an internal electron donor with one another, thereby forming a solid catalyst component containing titanium atoms, magnesium atoms and halogen atoms; and
(3) contacting the solid catalyst component, an organoaluminum compound and an external electron donor represented by the following formula (II) with one another; 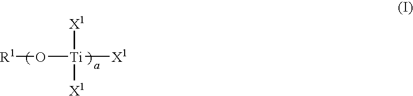
wherein R¹ is a hydrocarbyl group having 1 to 20 carbon atoms; X¹ is independently of one another a halogen atom or a hydrocarbyloxy group having 1 to 20 carbon atoms; and a is a number of 1 to 20; and
R²Si(OC₂H₅)₃ (II)
wherein R² is a hydrocarbyl group having 3 to 20 carbon atoms, and a carbon atom contained in the hydrocarbyl group and directly linked to the silicon atom is a secondary carbon atom.

2. The process according to claim 1, wherein a compound having a bond —C—O—C—O—C— is further brought into contact in the step (3).

3. The process according to claim 1, wherein the process comprises the following steps (2-1) and (2-2) between the steps (2) and (3):
(2-1) contacting the solid catalyst component containing titanium atoms, magnesium atoms and halogen atoms formed in the step (2) with an organoaluminum compound and an external electron donor represented by the following formula (IV), thereby forming a contact product; and
(2-2) polymerizing an α-olefin in the presence of said contact product, thereby forming a pre-polymerized solid catalyst component:
R³ₙSi(OR⁴)₄₋ₙ (IV)
wherein R³ is independently of one another a hydrocarbyl group having 1 to 20 carbon atoms, a hydrogen atom, or a heteroatom-containing group; R⁴ is independently of one another a hydrocarbyl group having 1 to 20 carbon atoms; and
n is a number of 1 to 3.

4. The process according to claim 3, wherein the external electron donor represented by the formula (IV) is a compound represented by the following formula (V):
R³⁷R³⁸Si(OCH₃)₂ (V)
wherein R³⁷ and R³⁸ are independently of each another a hydrocarbyl group having 1 to 20 carbon atoms, a hydrogen atom, or a heteroatom-containing group.

5. The process according to claim 3, wherein the external electron donor represented by the formula (IV) is a compound represented by the formula (II).

6. A process for producing an α-olefin polymer, comprising the step of homopolymerizing or copolymerizing an α-olefin in the presence of an α-olefin polymerization catalyst produced according to the process of claim 1.
